(19) United States
(12) Patent Application Publication
(10) Pub. No.: US 2023/0033302 A1
(43) Pub. Date: Feb. 2, 2023

(54) Food Preparation Utensil

(71) Applicant: Mary Ellison, Lapeer, MI (US)

(72) Inventor: Mary Ellison, Lapeer, MI (US)

(21) Appl. No.: 17/541,538

(22) Filed: Dec. 3, 2021

Related U.S. Application Data
(60) Provisional application No. 63/226,300, filed on Jul. 28, 2021.

(51) Int. Cl. A47J 43/28

(52) U.S. Cl. CPC A47J 43/285; A47J 43/288; A47J 43/281

(57) ABSTRACT

The present invention relates to a kitchen utensil in the form of a pronged spoon. The utensil has a handle attached to a head. The head is generally circular in shape and has a pronged tipped end. The pronged end has a plurality of tines, including a central tine, inner tines, middle tines and outer tines. A plurality of holes is disposed on the surface of the head for draining or straining excess water or liquid from the food item placed on the head. The handle can be telescopic and has an ergonomic grip for comfortable handling of the utensil.

### CROSS-REFERENCE TO RELATED APPLICATION

The present application claims priority to, and the benefit of, U.S. Provisional Application No. 63/226,300, which was filed on Jul. 28^{th}, 2021, and is incorporated herein by reference in its entirety.

### FIELD OF THE INVENTION

The present invention relates generally to the field of food preparation utensils. More specifically, the present invention relates to an improved cooking utensil that drains or strains liquid such as water, oil, fluids, juices or the like from a consumable item when the food item is lifted, scooped out or removed from a cooking or serving pot or pan. More specifically, the kitchen utensil has a forked spoon-shaped head that has holes through out the surface and the head also has a forked end that has a plurality of tapered and curvilinear fork tines or extensions. The holes aid in straining liquid or other fluids from the food item when placed on the head, and the fork tines help in scooping or removing the consumable item from the pot. Further, the fork tines also help in preventing the consumable item from falling off the head. The kitchen utensil or preparation tool enables users to drain liquid or other fluid when scooping or removing food and other consumable items from a pot of boiling water, cooking vessel or other similar dishware. Accordingly, the present disclosure makes specific reference thereto. Nonetheless, it is to be appreciated that aspects of the present invention are also equally applicable to other like applications, devices and methods of manufacture.

### BACKGROUND

By way of background, people use various forms of cutlery in preparing, serving and eating food and other consumable products. Cooking utensils such as a cooking pot, frying pan and others are used for preparing food items when food is cooked or otherwise prepared while on a grill, cooking surface or stove, and the food items are picked up from such cooking vessels for serving and further processing using a spoon and other cutlery. Generally, a spoon with an enlarged handle and an enlarged pick up surface is used by chefs and cooks in both professional and home kitchens for picking up food items from the cooking pot, vessel or the like. However, people find it inconvenient and inefficient to pick up food items using conventional spoons when there is a need to scoop or remove only the food item without excess water, liquid or other fluids leaving the pan in which the food is prepared. In such scenarios, people end up using additional devices such as a colander to drain water, juices and other liquid from the food items.

Usually, the spoon is used to allow food material and other items to be selectively-removed from the cooking pot, frying pan, vessel or other devices, such as a pan that is on a stove, cooking surface or a grill and then moved to a desired location, such as on a serving plate, bowl or the like, from where the obtained items may be consumed or further prepared. While prior and current spoons and other food preparation utensils do provide for the foregoing functionality, they do not readily allow food items to be scooped or removed from the pan without fully draining or straining associated liquid, water or other fluids. That is, by way of example and without limitation, when cooking or preparing items such as lettuce, pasta, vegetables and meats, it is desirable to selectively scoop out or remove only the food items from the liquid for serving and also for further processing or preparation. A spoon can be used to transport or move the food item from the pan. However a different tool, such as colander, or an extra step needs to be taken in order to drain extra liquid, water or other fluid scooped by the spoon. This makes the food items a bit spongy, and also makes the process of removing food from a pan burdensome and time-consuming.

For example, when cooking pasta, the pasta is boiled in water, which must be removed from the pasta before the pasta can be served. A conventional spoon or any other tong device cannot effectively remove the pasta alone, and the use of other devices is required, such as a colander in order to allow all the fluid to drain from the pasta.

Therefore, there exists a long felt need in the art for an improved cooking utensil that functions like a conventional spoon, but with an added feature of being easily able to drain liquid and other fluids from the scooped food items. There is also a long felt need in the art for an improved cooking utensil that eliminates the use of a colander, strainer or other similar utensil for straining water or fluids from food items. Additionally, there is a long felt need in the art for an improved cooking utensil that can be used with any type of cooking pan or pot. Moreover, there is a long felt need in the art for an improved cooking utensil that makes it easy for people to pull out food and other consumable items, such as cooking bags containing food, from a pot of boiling water or similar dishware. Further, there is a long felt need in the art for an improved cooking utensil that can be used easily in both professional and home kitchens. Furthermore, there is a long felt need in the art for an improved cooking utensil that has a large surface area to scoop out different types of food like vegetables, pasta, and more, and to hold them comfortably without concern of the food falling off the utensil. Finally, there is a long felt need in the art for an improved cooking utensil that better facilitates the draining or straining of liquids or fluids while scooping out or removing food items from a pot or similar dishware, thereby eliminating manual draining of the liquid.

The subject matter disclosed and claimed herein, in one embodiment thereof, comprises a multi-purpose kitchen utensil. The multi-purpose kitchen utensil helps in cooking, preparing and serving food items from a cooking pot, vessel or similar dishware without excess liquid or fluid being retained on the utensil or on the food. The multi-purpose kitchen utensil has an elongated arm that has an integrally-attached substantially circular-shaped food pick up head at its distal end. The substantially circular-shaped food pick up head has a curved-in, recessed area or concave spoon shaped curvature and further has a plurality of holes throughout the surface allowing water, fluid, or any other liquid to distill or drain while a food item is securely placed on the food pick up head. The head has a fork shape end positioned diametrically opposite to the attachment point of the substantially circular-shaped food pick up head with the elongated arm. The fork-shaped end has from between four to ten tines, with seven tines being preferred to allow food items to be securely picked up from the cooking vessel, while allowing water or the liquid to drain from the food or consumable product. Each tine has a curved or tapered shape to facilitate the picking up of the food product.

In this manner, the multi-purpose kitchen utensil of the present invention accomplishes all of the forgoing objectives and provides a relatively safe and cost-effective appliance to scoop out different types of food like vegetables, pasta and other consumable products. The utensil enables users to be able to easily drain liquid when scooping food items from a pot of boiling water or other similar vessels. The holes and tines better facilitate the draining of liquids and fluids, and eliminate the need for a separate process or additional utensils of removing liquids, fluid and other juices from food items or preparation packages.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a multi-purpose food preparation tool. The multi-purpose kitchen utensil is designed to help in cooking, preparing and serving food items from a cooking pot or similar vessel without removing excess liquid or other fluids from the cooking vessel. The multi-purpose kitchen utensil or food preparation tool includes an elongated arm that has a grip at the proximal end and has an integrally-attached substantially circular-shaped or oval-shaped food pick up head at the distal end. The substantially circular or oval-shaped food pick up head has a curved-in, recessed or concave-shaped curvature. The food pick up utensil or preparation tool further has a plurality of holes covering a substantial portion of its surface while allowing water, fluids or any other liquid to be removed or drained while a food item is securely held on the food pick up head. A fork-shaped end is positioned diametrically opposite to the attachment point of the substantially circular-shaped food pick up head with the elongated arm. The fork-shaped end has a number of tines, and in one particular embodiment the head has seven tines allowing food items to be securely picked up from the dishware, while allowing water or liquid to drain from the food. One or more tines may be in a curved configuration and have a tapered shape.

In yet another embodiment of the present invention, the tines include a central line and a first pair of additional tines providing a concentric configuration around the central tine, a pair of symmetric middle tines and a pair of symmetric inner tines. The pair of symmetric extreme tines are formed using the periphery or outer edge of the substantially circular-shaped food pick up utensil. Each of the tines, moving inwardly from the most outer edge to the inner edge having a differing angular arrangement, reducing the curvature until the central-most tine which is provided generally without any lateral, angular configuration. That is, the outermost tine having the most lateral, angular configuration and each inwardly-disposed tine reducing in its lateral, angular configuration until reaching the central-most tine which has no lateral angular configuration.

In yet another embodiment of the present invention, each tine of the substantially circular-shaped food pick up head is shaped to facilitate picking up the food and has a plurality of holes in each of the tines, ranging from 3 to 5 holes with four holes being preferred, for draining water or liquid from the picked food item. The holes in the outer most tines have smaller diameter holes compared to the central tine.

In yet another embodiment of the present invention, a food preparation tool or kitchen appliance for scooping or removing a food item from a pan, pot or similar preparation vessel while draining out scooped water, fluids or liquid in which the food item has been cooking, simmering or soaking is disclosed. The food preparation tool or kitchen appliance includes a handle having a proximal end and a distal end. The food pick up utensil has a concave-shaped top surface which is integrally connected to the distal end of the handle. The food pick up utensil includes a fork end with a plurality of fork tines extending outwardly from a central portion of the head allowing the kitchen appliance to be used as a big-forked spoon. The food pick up utensil has a plurality of holes generally throughout the top surface for draining any water, fluid or liquid scooped along the food item from the dishware. The holes also allow the water, fluid or liquid on the food item to be drained easily.

In yet another embodiment of the present invention, the kitchen appliance or food preparation tool has a plurality of holes on each of the fork tines, ranging from 3 to 5 holes per tine, with 4 holes preferred and the holes on the outermost tines being smaller than the holes on the inner most tines. The fork tines are tapered toward an end away from the central body and curved generally upward from the base of the head. In yet another embodiment, the concave-shaped food pick up utensil or food preparation tool can be integrally-connected or detachably-attached to the distal end of the handle.

In accordance with another embodiment of the present invention, a method is provided for easily scooping out or removing food items such as lettuce, pasta, vegetables and meats from the cooking liquids contained in a pot or pan using the present invention. The method includes the step of manually holding the handle and inserting the substantially circular forked spoon surface into a pan. Another step in the method is scooping out or removing the food item or food preparation pouch such that the food item is placed on concave-shaped top surface of the substantially circular forked spoon surface while liquid scooped out with the food item is drained through the holes on the forked spoon surface and tines.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the forked spoon kitchen utensil of the present invention in accordance with the disclosed architecture;

FIG. 2 illustrates close-up perspective views of one potential embodiment of the forked spoon area of the kitchen utensil of the present invention in accordance with the disclosed architecture and wherein the opening configuration of the spoon area and tines are emphasized;

FIG. 3 illustrates a perspective view of one potential embodiment of the forked spoon kitchen utensil of the present invention in use for draining liquid from a serving of pasta from a pot in accordance with the disclosed architecture;

FIG. 4 illustrates a perspective view of one potential embodiment of the forked spoon kitchen utensil of the present invention in use for lifting vegetables from a boiling pot and draining the liquid in accordance with the disclosed architecture; and

FIG. 5 illustrates a perspective view of another potential embodiment of the forked spoon kitchen utensil or food preparation tool of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved cooking utensil or food preparation tool that can be used as a serving tool that functions like a conventional spoon but with an added feature of automatically draining liquid and fluids from the scooped or removed food items. There is also a long felt need in the art for an improved cooking utensil that eliminates use of a colander, strainer or similar device for straining water, fluid and other liquids from food items. Additionally, there is a long felt need in the art for an improved cooking utensil or food preparation tool that can be used with any type of cooking pan, vessel or pot. Moreover, there is a long felt need in the art for an improved cooking utensil that makes it easy for people to pull out food items and food preparation packages from a pot of boiling water or similar vessel. Further, there is a long felt need in the art for an improved cooking utensil or food preparation tool that can be used easily in both professional and home kitchens. Furthermore, there is a long felt need in the art for an improved cooking utensil that has a large utensil surface area to scoop out and securely hold different types of foods like vegetables, pasta, and other items which may be made in cooking pots containing a liquid. Finally, there is a long felt need in the art for an improved cooking utensil or food preparation tool that better facilitates the draining, straining and removal of liquids and other fluids while scooping out or removing food items from a pot or similar cooking vessels, thereby eliminating the need for the manual draining of water or other liquids.

The present invention, in one exemplary embodiment, is a novel kitchen appliance or food preparation tool for scooping or removing a food item from a pan, pot or similar vessel while draining off water or liquid in which the food item is placed and which may be removed from the pot. The kitchen appliance includes a handle having a proximal end and a distal end. The food pick up utensil has a concave-shaped top surface that is integrally-connected to the distal end of the handle. The food pick up utensil has a fork end which includes a plurality of fork tines allowing the kitchen appliance to be used as a forked spoon. The food pick up utensil has a plurality of holes throughout the top surface for draining any water, fluid or liquid scooped along with the food item from the cooking pot. The holes allow the water or liquid on the food item to be drained easily. The holes may change in diameter from having larger holes centrally disposed of the head and smaller holes around the periphery of the head. The center holes remove more water or liquid as the water or liquid will collect in the central portion of the food preparation device.

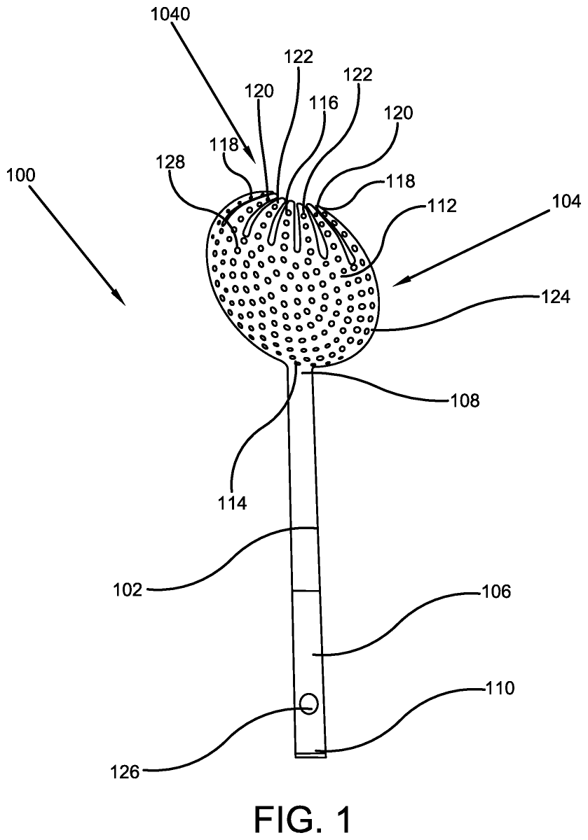

Referring initially to the drawings, FIG. 1 illustrates a perspective view of one potential embodiment of the forked spoon kitchen utensil of the present invention in accordance with the disclosed structure. The forked spoon kitchen utensil or food preparation tool 100 of the present invention is designed to enable users to scoop out different types of food items such as vegetables, pasta or the like, as well as food preparation pouches such as single serve food portions from a pan, pot or similar vessel while automatically draining, straining or removing liquid scooped along with the food item or pouch. More specifically, the kitchen utensil or food preparation tool 100 has an elongated handle 102 and concave contoured food pick spoon area of the head 104. The handle 102 has a proximal end 110 and a distal end 108. An ergonomic grip 106 is detachably-attached to the handle 102 near the distal end 108 that enables a user to easily handle and use the kitchen utensil 100. The grip 106 may provide insulation between the metal material of the tool 100 and the hand of the user. The grip 106 may be made of a deformable material such as polyurethane foam, silicone or combinations thereof to facilitate the gripping of the tool 100. The handle 102 has a mounting hole 126 that can be used for hanging the utensil 100 to a wall-mounted hook for easy storage. The ergonomic grip 106 can be made up of silicon, wood or nylon. Further, the handle 102 can be of Bakelite that does not allow the handle 102 to heat.

At the distal end 108 of the handle 102, the concave contoured food pick spoon area 104 is integrally-connected. The handle 102 and the spoon area 104 can be molded in a single molding operation. The forked spoon area 104 can be of a substantially circular or oval shape, and can have a non-stick coating. The spoon area 104 has a concave contour in the upper surface 112 and is attached to the distal end 108 at the first end 114. At the diametrically opposite position of the first end 114, the forked spoon head 104 has a forked end portion 1040 having a plurality of fork tines between 3 and 7 tines with 5 being preferred. In the preferred embodiment, there are seven fork tines at the forked end 1040, with three pairs of symmetric fork tines in a concentric arrangement and a central tine. The tines form a concentric configuration with a greater degree of curvature in the outermost tines as the move inwardly to the centermost tine. The outer most tines have a greater degree of lateral angularity, and the lateral curvature decreases as the tines move to the center of the forked area. As shown, the central tine 116, a pair of outermost tines 118, a pair of middle tines 120 and a pair of inner tines 122 form the seven fork tines for picking up food items, similar to a fork without breaking or grinding a food item. The tines form a concentric configuration with the curvature decreasing from the outermost tines to the center tine. The outermost tines 118 have a greater degree of curvature than the middle tines 120, which in turn have a greater degree of curvature than the inner tines 122. The center tine 116 does not have a lateral displacement. Preferably, a food item or food preparation package is picked from a pot, pan or similar vessel using on or more of the tines and is placed on the concave-shaped and recessed top surface 112. The slots between the tines, as well as the holes in the tines allow the liquid, oil or water to drain from the food items or food preparation packages and also support in picking up the food items or packages.

The concave contoured food pick forked spoon area 104 has a plurality of circular holes 128 that allows the liquid, oil, water or the like to drain during scooping or removing of the food item and also when the food item is placed on the forked spoon head 104. The holes 128 are also disposed on the fork tines 116, 118, 120, 122 allowing liquid, oil, water or other fluids to drain from the food item. In the present embodiment, each circular hole 128 has a diameter in the range 1-4 mm, with 1-2 mm being preferred. The holes that are disposed centrally of the tool head 104 are larger than the holes disposed in the periphery of the head 104. Likewise, the holes in the central tine 116 are generally larger than the holes in the outermost tines 118. The tines terminate at the periphery 124 of the head and extend generally upwardly from the recessed area of the head. The plurality of holes 128 form a draining zone that substantially covers the forked spoon area 104 that starts form the first end 114 to the fork tines. As a foodstuff, food preparation package or food item is scooped, removed or pulled, the holes 128 cause liquids, fluids and combinations thereof created during the cooking of the food items to be drained. Also, preferably, the holes 128 are provided around the rim or periphery 124 of the spoon area 104 and towards the central point of the spoon area 104. These holes may be oriented in the shape of concentric circles to the circular rim 124 of the spoon area 104. The number of holes in the tines ranges from 3-5 holes, with about 4 holes being preferred.

The size and shape of the holes 128 and the tines can be determined based on design preference and the type of liquid to be drained from food items. The holes 128 are small enough so that the food item does not pass through the holes while the liquid is being easily drained from food item or food preparation package.

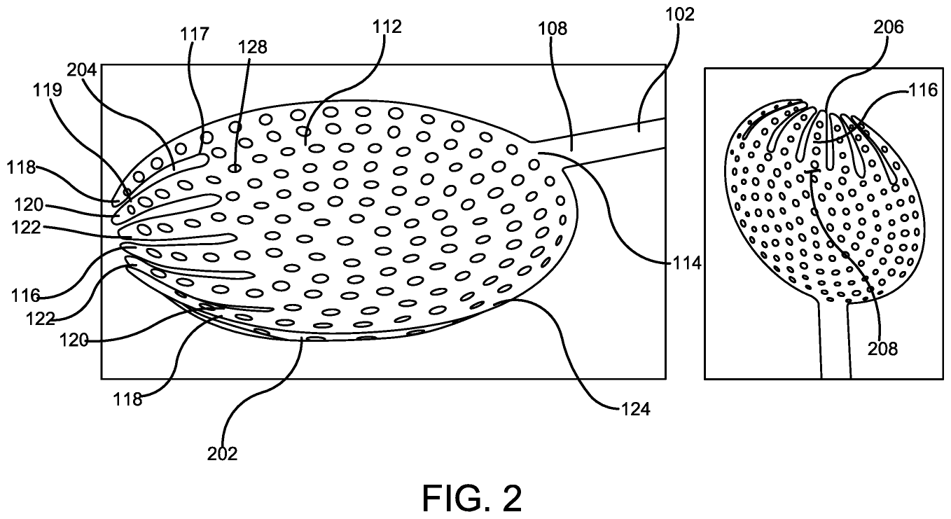

FIG. 2 illustrates a close view of the spoon head 104 having a plurality of tines 116, 118, 120 and 122 extending outwardly from an edge of the kitchen utensil or preparation tool 100 of the present invention in accordance with the disclosed structure. As shown, the top surface 112 of the spoon area 104 has a central area which is recessed below the periphery 124 of the preparation tool 100. The area is concave and contoured downwardly, enabling a food item to be securely placed on the top surface 102. When the kitchen device or preparation tool 100 is placed on a flat surface, the utensil or tool head 104 rests on the central part of the rear surface 202, and the rim 124 and the handle 102 do not touch the flat surface. As shown, the central tine 116, the pair of extreme tines 118, the pair of middle tines 120 and the pair of inner tines 122 have a slot or space 204 between adjacent tines, and the slot or space has a larger base 117 than the upper portion 119 between each of the tines. As shown through the zoomed-in version of the central tine 116 as an example, each tine has broader base and a narrowing leading edge end. As shown, the central tine 116 has a broader base 208 and the narrowing leading edge 206 providing a tapered and curvilinear shape such as an inverted and curved “V” shape to the central tine 116. Similar to the central tine 116, each of the other tines also have a broader base that narrows down to the corresponding closing or leading end of the tine for providing a tapered and curvilinear shape to the tines. It should be appreciated that the size of the holes 128 near the closed end of each tine can be less than the holes disposed near the base of the tines and also disposed on other portions of the forked spoon area 102. The holes at the base end are up to three times larger than the holes at the leading edge of each of the tines.

The rim 124 can be sharp or can be in the form of scooped or rounded edge that prevents the food item from being damaged by the rim 124 or tines. The handle 102 at the distal end 108 can be integrally or detachably-attached to the first end 114 of the spoon head 104. In case of the detachable connection, the handle 102 can be screwed to a hole disposed at the first end 114 or it can be another connection configuration such as a snap fit, magnetic combination, mechanical interlocking arrangement or combinations thereof

For providing adequate space and surface for scooping, removing and placing the food items or consumer good preparation packages on the top surface 112, the length of the tines range to 20%-30% of the overall diameter of the spoon area 104. Preferably, the leading end of each tine can have the width in the range 1-2 mm and the base can have the width in the 3-5 mm.

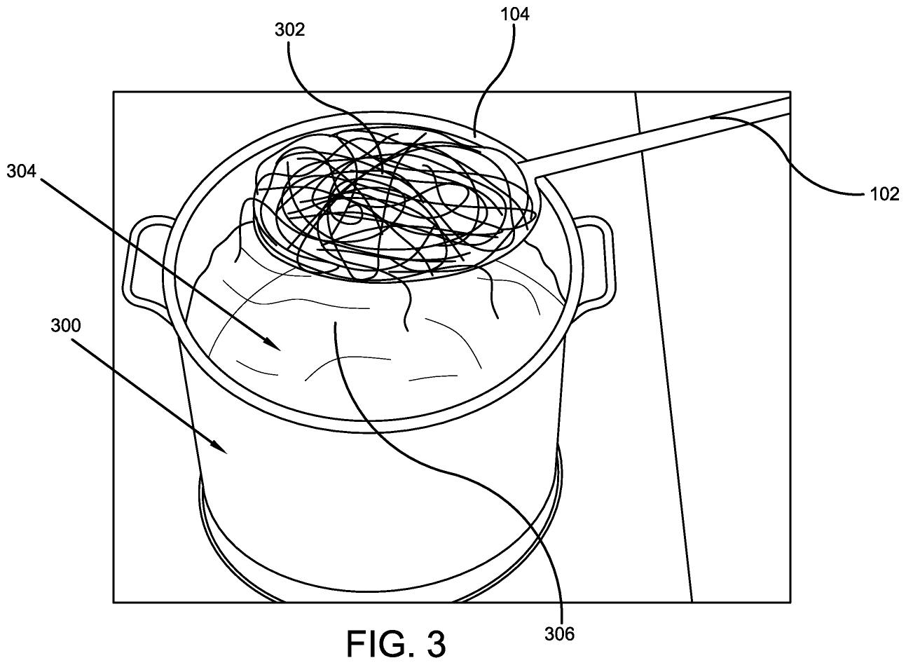

FIG. 3 illustrates a perspective view showing the kitchen utensil or preparation tool of the present invention in use for draining pasta from a pot in accordance with the disclosed specification. As shown, pasta 302 is illustrated as being cooked or prepared in hot water 304 in a pot 300, and is scooped out or removed using the kitchen utensil 100. The utensil 100 is held by an individual using the handle 102, and the pronged spoon area 104 is inserted into the water 304 in the pot 300. The pasta 302 is pulled out by sliding the pronged spoon area 104 beneath the pasta 302 and by sliding the pronged spoon area 104 along the base of the pot 300. The pasta 302 is positioned on the top surface of the spoon area 104 and the holes 128 allow the water or other liquid to be drained in the form of drops or streams 306 to provide the desired drained pasta 302, thereby eliminating the need to use an additional device such as a colander or strainer to complete the draining or straining. The concave contour of the spoon area 104 allows the pasta 302 to be securely placed or positioned on the spoon area 104 and can be used for further processing or serving.

It should be appreciated that the spoon area 104 can be used for flushing excess oil, water or other liquid, which is not absorbed by the pasta 302, thus providing a good oil and liquid removal effect. Using the utensil or tool 100, even the small fragments of the pasta 302 can be easily scooped out without collecting the water or oil in which the pasta 302 is cooked. The long handle 102 allows the utensil 100 to be used even in deep cooking pots or vessels.

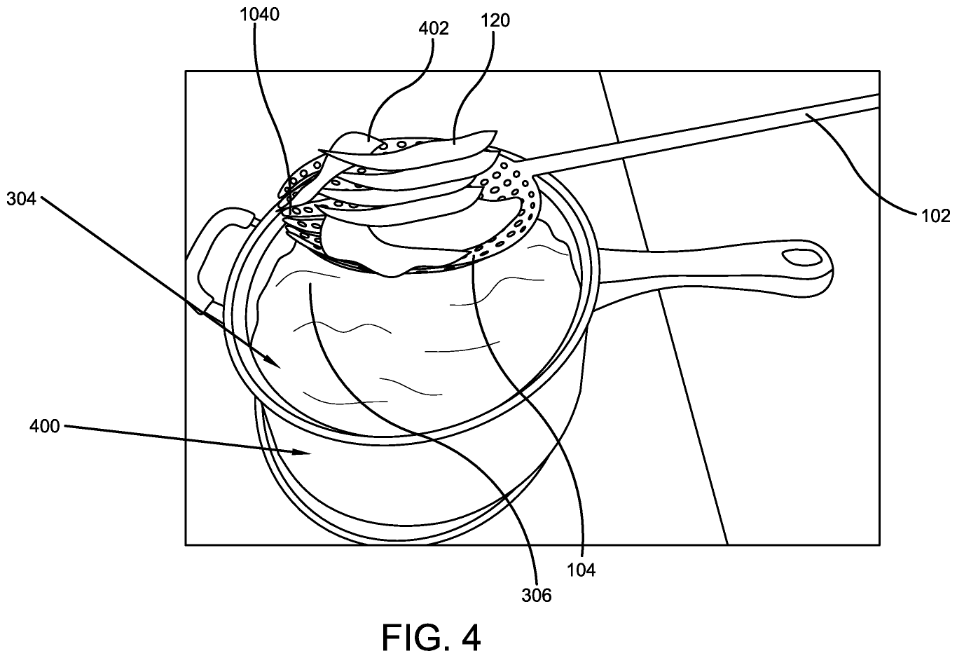

FIG. 4 illustrates a perspective view showing the pronged spoon kitchen utensil or preparation tool of the present invention in use for lifting vegetables from a boiling pot in accordance with the disclosed specification. As shown, vegetables 402 being cooked in hot water 304 in a boiling pot 400 are lifted using the kitchen utensil or preparation tool 100 of the present invention. The utensil or tool 100 is held by an individual using the handle 102 and the pronged spoon area 104 is inserted into the water 304 in the boiling pot 400. The vegetables 402 are lifted by sliding the pronged spoon area 104 beneath the vegetables 402 and placing vegetables 402 on the top surface of the spoon area 104. The holes 128 allow the water 304 to be drained in the form of drops or streams 306 to provide the dry and drained vegetables, thereby eliminating the need to use an additional device such as a colander or strainer.

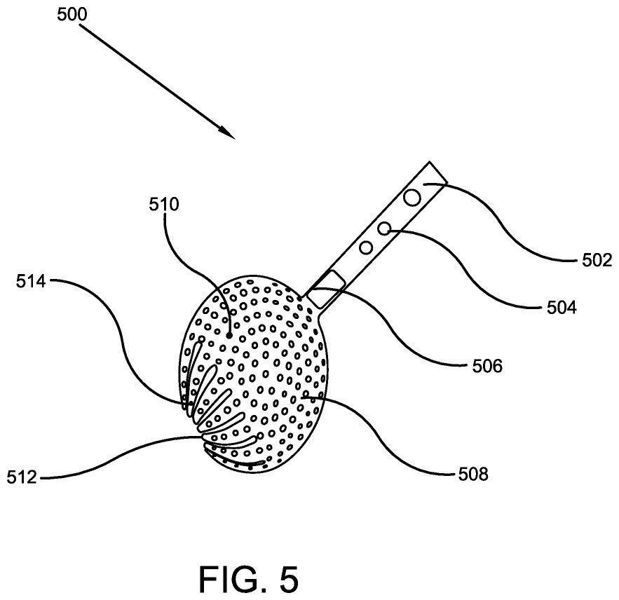

FIG. 5 illustrates a perspective view showing another potential embodiment of the pronged spoon kitchen utensil or preparation tool of the present invention in accordance with the disclosed specification. In the present embodiment, the handle 502 is a telescopic handle having a plurality of telescoping slots 504 allowing the handle 502 to extend or retract. Further, the handle 502 is detachably-connected to the spoon head 508 at connector 506, thereby enabling a user to detach the handle 502 as needed for storage or changing with other heads that may be used with the handle such as a fork, knife or implement. The spoon head 508 has holes 510 disposed on the complete surface and the pronged end 512 has a plurality of tines 514.

The kitchen utensil or preparation tool 100, 500 of the present invention is not limited to cooking but can be used for draining excess liquid from other foods, such as pickles, olives and the like, as well as for other food preparation activities. Further, the tines keep the foodstuff from falling off of the pronged head as the excess liquid or other fluids are being drained.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “forked spoon kitchen utensil”, “kitchen utensil”, “utensil”, and “kitchen device”, are interchangeable and refer to the forked spoon kitchen utensil 100,500 of the present invention.

Notwithstanding the forgoing, forked spoon kitchen utensil 100,500 of the present invention can be of any suitable size and configuration as is known in the art without affecting the overall concept of the invention, provided that it accomplishes the above-stated objectives. One of ordinary skill in the art will appreciate that the size, configuration, and material of the forked spoon kitchen utensil 100,500 as shown in the FIGS. are for illustrative purposes only, and that many other sizes and shapes of the forked spoon kitchen utensil 100,500 are well within the scope of the present disclosure. Although the dimensions of the disposable cover for forked spoon kitchen utensil 100,500 are important design parameters for user convenience, the forked spoon kitchen utensil 100,500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A food preparation tool comprising:
a handle having a proximal and a distal end, the proximal end having a gripping area configured for holding the handle; and
a head connected to the distal end of the handle, the head having a perimeter and one of a circular or an oval shape, wherein the head further comprises an area recessed into the perimeter of the head and a leading edge disposed opposite the handle distal end and at least one tine extending generally upwardly from the area and terminating at the leading end.

2. The food preparation tool as recited in claim 1, wherein the head comprises a plurality of tines extending generally upwardly from the area and terminating at the leading end.

3. The food preparation tool as recited in claim 2, wherein the plurality of tines comprises a central tine, two inner tines and two outer tines.

4. The food preparation tool as recited in claim 3, wherein the plurality of tines further comprises two middle tines disposed between the inner tines and the central tine.

5. The food preparation tool as recited in claim 2, wherein a space is provided between each of the plurality of tines.

6. The food preparation tool as recited in claim 5, wherein the space has a broader base area and a narrower area toward a leading edge of each of the plurality of tines and adjacent the periphery of the head.

7. The food preparation tool as recited in claim 2, wherein each of the plurality of tines is provided with a plurality of holes diminishing in size as the plurality of tines lead toward the periphery.

8. The food preparation tool as recited in claim 2, wherein each of the plurality of tines tapers from a base toward the periphery of the head, creating the base which is larger than a leading edge of each of the plurality of tines.

9. The food preparation tool as recited in claim 1, wherein the head includes a plurality of openings substantially covering the area.

10. The food preparation tool as recited in claim 9, wherein the plurality of openings are large in a central portion of the area and smaller near the periphery of the head.

11. A cooking utensil comprising:
a circular head comprised of a central area, a perimeter and a plurality of holes substantially covering the circular head, wherein the plurality of holes are larger in the central area than the plurality of holes near the perimeter and further wherein the central area is recessed below the perimeter of the circular head;
a handle connected to the circular head and comprised of a proximal end and a distal end; and
a plurality of tines disposed at an edge of the circular head opposite the handle, wherein the plurality of tines comprise a base adjacent the central area and a terminating end, and further wherein the plurality of times are larger at the base than at the terminating end.

12. The cooking utensil as recited in claim 11, wherein each of the plurality of tines comprise holes extending from the base of the plurality of tines to the terminating end.

13. The cooking utensil as recited in claim 12, wherein the holes near the base of each of the plurality of tines is larger than the holes near the terminating end of the plurality of tines.

14. The cooking utensil as recited in claim 11, wherein each of the plurality of tines has a width at the base ranging from 3-5 mm and a width of 1-2 mm at the terminating end of the plurality of tines.

15. The cooking utensil as recited in claim 11, wherein the plurality of tines comprise a central tine, two inner tines and two outermost tines.

16. The cooking utensil as recited in claim 15, wherein the plurality of tines further comprise middle tines between the inner tines and the central tine.

17. The cooking utensil as recited in claim 11, wherein handle comprises a gripping area at the distal end and further wherein the gripping area is comprised of a deformable material.

18. A pronged spoon utensil comprising:
a handle having a proximal and distal end, with the distal end having a deformable gripping surface and a circular head attached to the proximal end;
the head having a plurality of holes disposed substantially throughout an area of the head, the holes in a central portion of the area larger than holes adjacent a perimeter of the head;
a plurality of tines disposed at an end of the head opposite the handle, the plurality of tines each having a series of holes, and each of the tines having a base with a larger width than a width of a terminating end; and
each of the tined spaced from one anther a distance at the base greater than a distance at the terminating end.

19. The pronged spoon utensil as recited in claim 18, wherein the plurality of tines comprise a central tine, inner tines, middle tines and outer tines.

20. The pronged spoon utensil as recited in claim 18, wherein the plurality of times comprise two inner tines, two middle tines and two outer tines.
